(19) United States
(12) Patent Application Publication
(10) Pub. No.: US 2010/0012811 A1
(43) Pub. Date: Jan. 21, 2010

(54) Adjustable leg

(75) Inventors: Ken MacKenzie, Madison, WI (US); Ronald J. Pulvermacher, Sun Prairie, WI (US)

Correspondence Address: RYAN KROMHOLZ & MANION, S.C., POST OFFICE BOX 26618, MILWAUKEE, WI, 53226, US

(73) Assignee: WICKCRAFT COMPANY, INC

(21) Appl. No.: 12/459,902

(22) Filed: Jul. 9, 2009

Related U.S. Application Data
(60) Provisional application No. 61/134,460, filed on Jul. 10, 2008.

(51) Int. Cl. A47B 91/00; F16M 13/00

(52) U.S. Cl. 248/423; 248/157

(57) ABSTRACT

An adjustable leg includes a foot assembly, a leg assembly, a tube assembly and a rod assembly. The foot assembly is coupled to the leg assembly. The rod assembly is rotatably coupled to the tube assembly. The rod assembly is threaded through an aperture in the leg assembly and the tube assembly. The rotation of the rod assembly adjusts the overall length of the adjustable leg. Engagement of the leg assembly with the inside of the tube assembly prevents the rotation of the tube assembly when the rod assembly is rotated.

### RELATED APPLICATIONS

This application claims the benefit of U.S. Provisional Patent Application Ser. No. 61/134,460, filed 10 Jul. 2008, and entitled “Adjustable Leg.”

### BACKGROUND OF THE INVENTION

Boat docks, piers, and walkways are generally made of several flat walkway segments coupled to each other. Each flat walkway segment generally includes several legs to lift the walkway segments off the ground. The ground on which the walkway segments are placed is generally not flat. Further, when docks are placed in the water, the water level often changes due to weather conditions. Therefore it is desirable to provide the walkway segments with adjustable legs. The legs used in the field are generally adjustable, however, such legs are generally only adjustable to a few predetermined positions as shown in FIG. 1, in other words only coarse adjustment is available. However, it is desirable to provide an adjustable leg that can provide fine adjustment.

### SUMMARY OF THE INVENTION

The present invention provides an adjustable leg including a foot assembly, a let assembly slidably coupled to the foot assembly, a tube assembly slidably positioned on the leg assembly and a rod assembly rotatably coupled to the leg assembly and the tube assembly.

The foot assembly of the adjustable leg may include a first hollow tubular member having a first end and a second end and a base plate having a top surface and a bottom surface. The second end of the first hollow tubular member being coupled to the top surface of the base plate such that the first hollow tubular member extends generally perpendicularly from the surface of the base plate.

The first hollow tubular member of the adjustable leg may include has a plurality of spaced-apart adjustment holes formed therethrough.

The first hollow tubular member of the adjustable leg may have a generally rectangular cross-section.

The leg assembly of the adjustable leg may include a second hollow tubular member having a first end and a second end and a retaining plate having a top surface and an opposed bottom surface, the retaining plate having an aperture therethrough. The first end of the second hollow tubular member is preferably coupled to the bottom surface of the retaining plate.

The second hollow tubular member of the adjustable leg may include a plurality of spaced-apart adjustment holes formed therethrough near the second end thereof.

The second hollow tubular member of the adjustable leg may include a generally rectangular cross-section.

The second end of the second hollow tubular member of the adjustable leg may be arranged inside the first hollow tubular member.

The tube assembly of the adjustable leg may include a generally third hollow tubular member having a first end and a second end and a cap having a top surface and an opposed bottom surface, the cap has an aperture therethrough. The first end of the third hollow member may be coupled to the bottom surface of the cap, the third hollow tubular member extending generally perpendicularly from the bottom surface of the cap.

The tube assembly of the adjustable leg may fit over the leg assembly such that the first end of the second hollow tubular member sits inside the third hollow tubular member.

The third hollow tubular member of the adjustable leg may have a generally rectangular cross-section.

The rod assembly of the adjustable leg may include a threaded rod having a first end and a second end, the threaded rod having an attachment portion formed at the first end.

The attachment portion of the rod assembly of the adjustable leg may include a reduced diameter portion forming a shoulder on the threaded rod, a head formed at the first end of the threaded rod, and a groove extending around the diameter of the reduced portion of the rod near the head.

The threaded rod of the adjustable leg may extend through the aperture in the cap of the tube assembly and the aperture in the retaining plate of the leg assembly.

The adjustable leg may include a retaining member is placed in the groove of the attachment portion.

The cap of the tube assembly of the adjustable leg may be engaged by and between the shoulder portion of the threaded rod and the retaining member.

The first hollow tubular member and the second hollow tubular member of the adjustable leg may each have a plurality of apertures therethrough.

The adjustable leg may include at least one fixation device inserted through aligned apertures in the first hollow tubular member and the second hollow tubular member.

The invention further provides a method including providing an adjustable leg, the adjustable leg, the adjustable leg assembly including a foot assembly including a first hollow tubular member having a first end and a second end and a base plate having a top surface and a bottom surface, wherein the second end of the first hollow tubular member is coupled to the top surface of the base plate such that the first hollow tubular member extends generally perpendicularly from the surface of the base plate, a plurality of apertures being formed through the first hollow tubular member. The adjustable leg further including a leg assembly, slidably coupled to the foot assembly, the leg assembly including a second hollow tubular member having a first end and a second end and a retaining plate having a top surface and an opposed bottom surface, the retaining plate having an aperture therethrough, wherein the first end of the second hollow tubular member is preferably coupled to the bottom surface of the retaining plate, a plurality of apertures being formed through the second hollow tubular member. The adjustable leg further including a tube assembly slidably positioned on the leg assembly, the tube assembly including a generally third hollow tubular member having a first end and a second end and a cap having a top surface and an opposed bottom surface, the cap has an aperture therethrough, wherein the first end of the third hollow member is preferably coupled to the bottom surface of the cap, the third hollow tubular member extending generally perpendicularly from the bottom surface of the cap. The adjustable leg further including a rod assembly rotatably coupled to the leg assembly retaining plate and the tube assembly cap, the rod assembly including a threaded rod having a first end and a second end, the threaded rod having an attachment portion formed at the first end. The method further including performing a coarse adjustment to the length of the adjustable leg and performing a fine adjustment to the length of the adjustable leg.

The performing a coarse adjustment step further of the method may include sliding the leg assembly relative to the foot assembly, aligning a leg assembly aperture with a foot assembly aperture, and inserting a fastening member through the pair of aligned apertures.

The performing a fine adjustment step of the method may include rotating the threaded rod to adjust the length of the threaded rod that extends outwardly from the leg assembly retaining plate.

### BRIEF DESCRIPTION OF THE DRAWINGS

FIG. 1 is a perspective view of a prior art adjustable leg.

FIG. 2 is a perspective view of an adjustable leg according to the present invention.

FIG. 3 is an exploded view of the adjustable leg of FIG. 1.

FIG. 3A is a partial close up view of the adjustable leg of FIG. 3.

FIG. 4 is a partially cut away perspective view of the adjustable leg of FIG. 1 in its expanded position.

FIG. 5 is a partially cut away perspective view of the adjustable leg of FIG. 1 in its retracted position.

FIG. 6 is a perspective view of the adjustable leg of FIG. 2 in use with a walkway section.

FIG. 7 is a side view of the adjustable leg of FIG. 2 in use with an alternative walkway section.

FIG. 8 is a top view of the alternative embodiment of FIG. 7.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

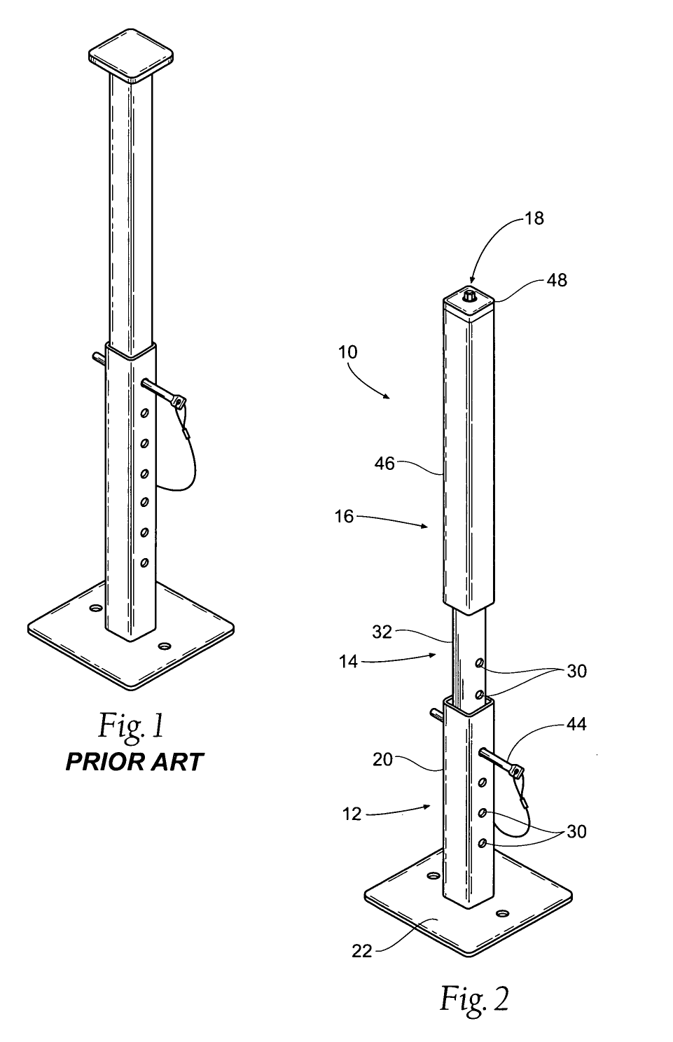

As shown in FIG. 2, the invention 10 preferably includes a foot assembly 12, a leg assembly 14, a tube assembly 16 and a rod assembly 18. The foot assembly 12 is coupled to the leg assembly 14. The rod assembly 18 is coupled to both the leg assembly 14 and the tube assembly 16.

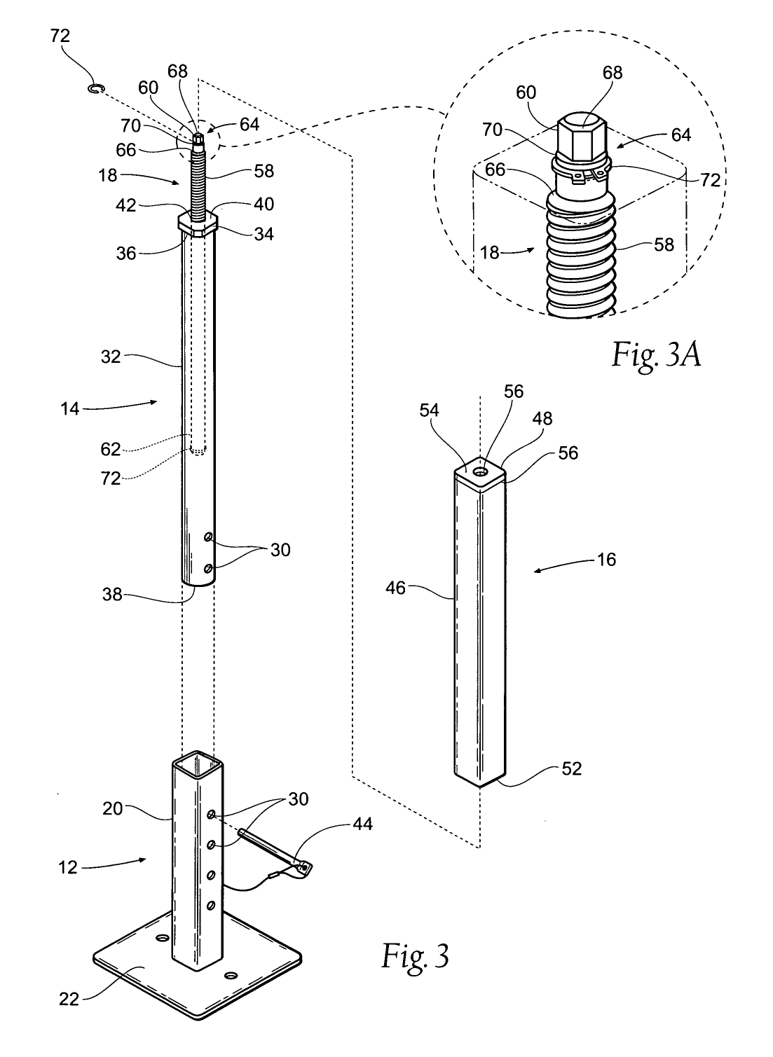

As seen in FIG. 3, the foot assembly 12 preferably includes a generally first hollow tubular member 20 and a base plate 22. The first hollow tubular member 20 has a first end 24 and an opposed second end 26. The base plate 22 has a top surface 28 and an opposed bottom surface (not shown). The second end 26 of the first hollow member 20 is preferably coupled to the top surface 28 of the base plate 22. The first hollow tubular member 20 extends generally perpendicularly from the surface 28 of a base plate 22. The first hollow tubular member 20 preferably has a plurality of spaced-apart adjustment holes 30 formed therethrough. In the illustrated embodiment the first hollow tubular member 20 has a generally rectangular cross-section; however it is contemplated that the first hollow tubular member 20 could have various other cross-sections known in the art.

As seen in FIG. 3, the leg assembly 14 preferably includes a second hollow tubular member 32 and a retaining plate 34. The second hollow tubular member 32 has a first end 36 and an opposed second end 38. The retaining plate 34 has a top surface 40 and an opposed bottom surface (not shown). The retaining plate 34 preferably has an aperture 42 therethrough to accept the rod assembly 18 as will be described in more detail below. The first end 36 of the second hollow tubular 32 member is preferably coupled to the bottom surface of the retaining plate 34. The second hollow tubular member 32 preferably has a plurality of spaced-apart adjustment holes 30 formed therethrough near the second end 38. In use the second end 38 of the second hollow tubular member 32 is arranged inside the first hollow tubular member 20. Preferably, a set of adjustment holes 30 in the first hollow tubular member 20 is aligned with a set of adjustment holes 30 in the second hollow tubular member 32. A fixation device 44 such as a pin is then placed through the aligned adjustment holes 30 to fix the leg assembly 14 to the foot assembly 12. In the illustrated embodiment the second hollow tubular member 32 has a generally circular cross-section; however it is contemplated that the second hollow tubular member 32 could have various other cross-sections known in the art.

As seen in FIG. 3, the tube assembly 16 preferably includes a generally third hollow tubular member 46 and a cap 48. The third hollow tubular member 46 has a first end 50 and an opposed second end 52. The cap has a top surface 54 and an opposed bottom surface (not shown). The cap 48 preferably has an aperture 56 therethrough to accept the rod assembly 18 as will be described in more detail below. The first end 50 of the third hollow member 46 is preferably coupled to the bottom surface of the cap 48. The third hollow tubular member 46 preferably extends generally perpendicularly from the bottom surface of the cap 48. Preferably the tube assembly 16 fits over the leg assembly 14 such that the first end 36 of the second hollow tubular member 32 sits inside the third hollow tubular member 46. In the illustrated embodiment the third hollow tubular member 46 has a generally rectangular cross-section; however it is contemplated that the third hollow tubular member 46 could have various other cross-sections known in the art.

As seen in FIG. 3, the rod assembly 16 of the illustrated embodiment is threaded rod 58. The threaded rod 58 has a first end 60 and an opposing second end 62. An attachment portion 64 is preferably formed at the first end 60 of the threaded rod 58. The attachment portion 64 preferably has a reduced diameter, forming a shoulder 66 on the threaded rod 58. The attachment portion 64 further includes a head 68 formed at the first end 60 of the threaded rod 58 and a groove 70 formed near the head 68. The threaded rod 58 extends through the aperture 56 in the cap 48 of the tube assembly 16 and the aperture 42 in the retaining plate 34 of the leg assembly 14. In use, the second end 62 of the threaded rod 58 is threaded into the aperture 42 in the retaining plate 34 and the tube assembly 16 is placed over the first end 60 of the threaded rod 58. A retaining member 72 such as a snap ring is snapped into the groove 70. In this manner the tube assembly 16 is rotatably coupled to the rod assembly 18. As seen in FIG. 3 the cap 48 is retained between the shoulder portion 66 of the threaded rod 58 and the retaining member 72, preventing longitudinal motion between the tube assembly 16 and the threaded rod 18. In the illustrated embodiment the head 68 has a hex-shaped configuration. In this manner, the threaded rod 58 may be rotated by a standard tool such as a wrench. It is contemplated that the configuration of the head 68 may take any configuration known in the art. When the rod assembly 18 is rotated, the length of the threaded rod 58 that extends from the retaining member 34 is adjusted. In this manner the height of the leg 10 is adjusted. It should be understood that leg member 14 is prevented from rotating by the engagement of the retaining plate 34 with the interior of the tube assembly 16.

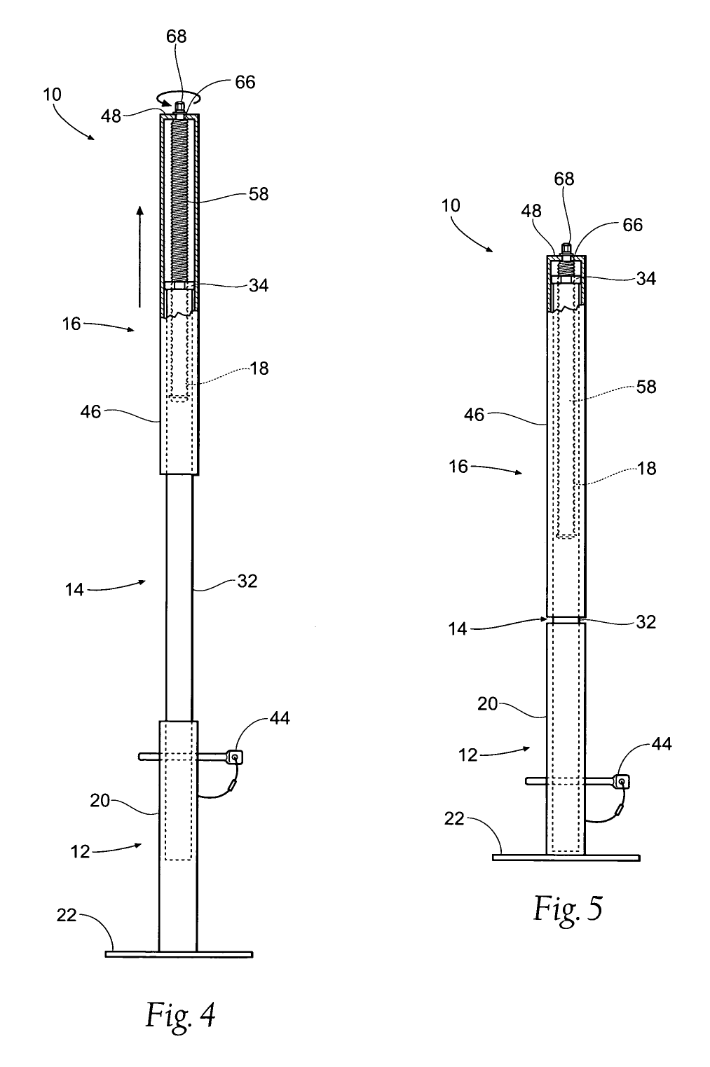

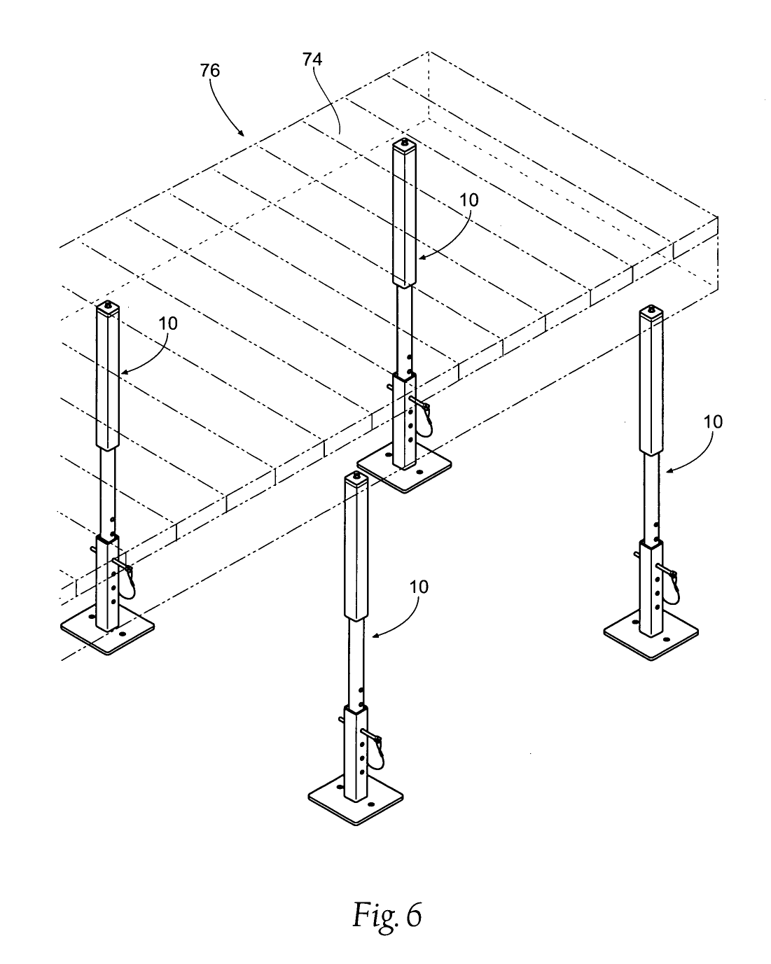

The length of the adjustable leg 10 may be adjusted between a first maximum length (see FIG. 4) and a second minimum length (see FIG. 5). As seen in FIG. 6, it is contemplated that a plurality of adjustable legs 10 may be attached to a walkway member 74 to form a walkway 76. The adjustable legs 10 may be attached to the walkway member 74 in any manner known in the art. In this manner, the walkway 76 may be easily adjusted, for example to level the walkway 76 or match the height of a walkway section 76 to an adjacent walkway section 76, by adjusting at least one of the plurality of adjustable legs 10.

It is contemplated that a coarse adjustment of the height of the adjustable leg 10 aligning a set of adjusting holes 30 in the first hollow member 20 with a set of adjusting holes 30 in the second hollow member 32 and inserting a fixation device 44 such as a pin through the aligned adjusting holes 30. In this manner the fixation device 44 will extend through both the foot assembly 12 and the leg assembly 14 and will hold the foot assembly 12 and the leg assembly 14 in their relative positions. Once the coarse adjustment is set, threaded rod 58 may be rotated to either retract or expand the adjustable leg 10 to set the fine adjustment.

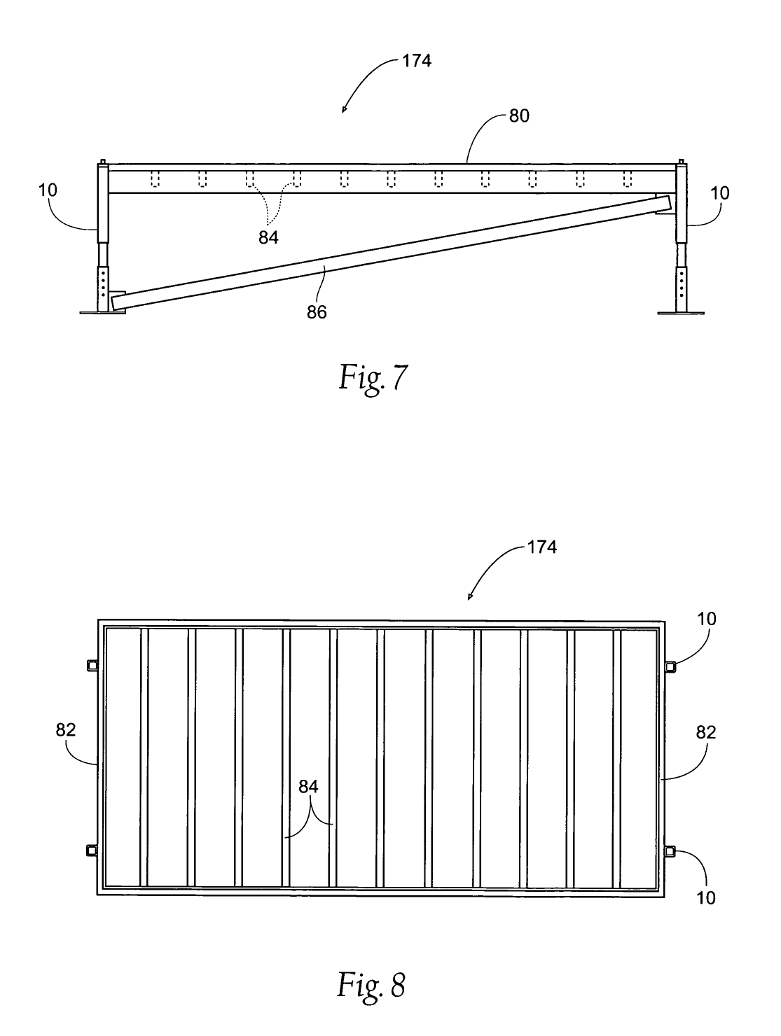

FIGS. 7 and 8 show the adjustable leg utilized with an alternative embodiment of a walkway member 174. The alternative walkway member includes a pair of opposed side members 80 and a pair of opposed end member 82. The side members 80 82 and end members may take any form known in the art, but preferably are tubular members. The walkway member 174 preferably includes a plurality of cross members 84 extending between the side members 80. The cross members 84 may take any form known in the art. Preferably, at least four adjustable legs 10 are coupled to the walkway member 174. The adjustable legs 10 may be coupled to the walkway member 174 using any means known in the art. In the illustrated embodiment a pair of adjustment legs 10 are attached to each end member 82. The embodiment of FIGS. 7 and 8 preferably includes a diagonal bracing 86 between two oppositely disposed adjustable legs 10.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. An adjustable leg comprising:
a foot assembly;
a leg assembly, slidably coupled to the foot assembly;
a tube assembly slidably positioned on the leg assembly; and
a rod assembly rotatably coupled to the leg assembly and the tube assembly.

2. The adjustable leg of claim 1 wherein the foot assembly further comprises:
a first hollow tubular member having a first end and a second end; and
a base plate having a top surface and a bottom surface;
wherein the second end of the first hollow tubular member is coupled to the top surface of the base plate such that the first hollow tubular member extends generally perpendicularly from the surface of the base plate.

3. The adjustable leg of claim 2 wherein the first hollow tubular member has a plurality of spaced-apart adjustment holes formed therethrough.

4. The adjustable leg of claim 2 wherein the first hollow tubular member has a generally rectangular cross-section.

5. The adjustable leg of FIG. 2 wherein the leg assembly further comprises:
a second hollow tubular member having a first end and a second end; and
a retaining plate having a top surface and an opposed bottom surface, the retaining plate having an aperture therethrough;
wherein the first end of the second hollow tubular member is preferably coupled to the bottom surface of the retaining plate.

6. The adjustable leg of claim 5 wherein the second hollow tubular member has a plurality of spaced-apart adjustment holes formed therethrough near the second end thereof.

7. The adjustable leg of claim 5 wherein the second hollow tubular member has a generally rectangular cross-section.

8. The adjustable leg of claim 5 wherein the second end of the second hollow tubular member is arranged inside the first hollow tubular member.

9. The adjustable leg of claim 5 wherein the tube assembly further comprises:
a generally third hollow tubular member having a first end and a second end; and
a cap having a top surface and an opposed bottom surface, the cap has an aperture therethrough;
wherein the first end of the third hollow member is preferably coupled to the bottom surface of the cap, the third hollow tubular member extending generally perpendicularly from the bottom surface of the cap.

10. The adjustable leg of claim 9 wherein the tube assembly fits over the leg assembly such that the first end of the second hollow tubular member sits inside the third hollow tubular member.

11. The adjustable leg of claim 9 wherein the third hollow tubular member has a generally rectangular cross-section.

12. The adjustable leg of claim 9 wherein the rod assembly further comprises:
a threaded rod having a first end and a second end, the threaded rod having an attachment portion formed at the first end.

13. The adjustable leg of claim 12 wherein the attachment portion further comprises:
a reduced diameter portion forming a shoulder on the threaded rod;
a head formed at the first end of the threaded rod; and
a groove extending around the diameter of the reduced portion of the rod near the head.

14. The adjustable leg of claim 13 wherein the threaded rod extends through the aperture in the cap of the tube assembly and the aperture in the retaining plate of the leg assembly.

15. The adjustable leg of claim 14 wherein a retaining member is placed in the groove.

16. The adjustable leg of claim 15 wherein the cap of the tube assembly is engaged by and between the shoulder portion of the threaded rod and the retaining member.

17. The adjustable leg of claim 5 wherein the first hollow tubular member and the second hollow tubular member each have a plurality of apertures therethrough.

18. The adjustment leg of claim 17 further comprising at least one fixation device inserted through aligned apertures in the first hollow tubular member and the second hollow tubular member.

19. A method comprising:
providing an adjustable leg, the adjustable leg, the adjustable leg assembly including:
a foot assembly including a first hollow tubular member having a first end and a second end and a base plate having a top surface and a bottom surface, wherein the second end of the first hollow tubular member is coupled to the top surface of the base plate such that the first hollow tubular member extends generally perpendicularly from the surface of the base plate, a plurality of apertures being formed through the first hollow tubular member;
a leg assembly, slidably coupled to the foot assembly, the leg assembly including a second hollow tubular member having a first end and a second end and a retaining plate having a top surface and an opposed bottom surface, the retaining plate having an aperture therethrough, wherein the first end of the second hollow tubular member is preferably coupled to the bottom surface of the retaining plate, a plurality of apertures being formed through the second hollow tubular member;
a tube assembly slidably positioned on the leg assembly, the tube assembly including a generally third hollow tubular member having a first end and a second end and a cap having a top surface and an opposed bottom surface, the cap has an aperture therethrough, wherein the first end of the third hollow member is preferably coupled to the bottom surface of the cap, the third hollow tubular member extending generally perpendicularly from the bottom surface of the cap; and
a rod assembly rotatably coupled to the leg assembly retaining plate and the tube assembly cap, the rod assembly including a threaded rod having a first end and a second end, the threaded rod having an attachment portion formed at the first end;
performing a coarse adjustment to the length of the adjustable leg; and
performing a fine adjustment to the length of the adjustable leg.

20. The method of claim 19 wherein the performing a coarse adjustment step further comprises:
sliding the leg assembly relative to the foot assembly;
aligning a leg assembly aperture with a foot assembly aperture; and
inserting a fastening member through the pair of aligned apertures.

21. The method of claim 19 wherein the performing a fine adjustment step further comprises rotating the threaded rod to adjust the length of the threaded rod that extends outwardly from the leg assembly retaining plate.
